(19) United States
(12) Patent Application Publication
(10) Pub. No.: US 2013/0070788 A1
(43) Pub. Date: Mar. 21, 2013

(54) Method and Apparatus for Interchanging Data, and Network

(71) Applicants: Karl-Heinz Deiretsbacher, Effeltrich (DE); Stefan Elsterer, Furth (DE); Christian Hock, Furth (DE); Jörn Peschke, Nurnberg (DE); Frank Volkmann, Nurnberg (DE)

(72) Inventors: Karl-Heinz Deiretsbacher, Effeltrich (DE); Stefan Elsterer, Furth (DE); Christian Hock, Furth (DE); Jörn Peschke, Nurnberg (DE); Frank Volkmann, Nurnberg (DE)

(73) Assignee: Siemens Aktiengesellschaft, Muenchen (DE)

(21) Appl. No.: 13/700,006

(22) PCT Filed: Apr. 26, 2011
(86) PCT No.: PCT/EP11/56559

§ 371 Date: Nov. 26, 2012

(30) Foreign Application Priority Data
May 25, 2010 (DE) 10 2010 021 472.8

(51) Int. Cl. H04L 29/10

(52) U.S. Cl. CPC H04L 29/10
USPC 370/466

(57) ABSTRACT

A method for interchanging data between two devices in a network which utilizes a communication protocol with an interface based on the OPC-UA standard to interchange the data, wherein the communication protocol comprises an interface based on the stream reservation protocol standard or an interface based on the multiple stream registration protocol standard in accordance with IEEE standard 802.1Qat, such that the data is interchangeable between the two devices using both interfaces in a prescribed period of time.

### CROSS-REFERENCE TO RELATED APPLICATIONS

This is a U.S. national stage of application No. PCT/EP2011/056559 filed 26 Apr. 2011. Priority is claimed on German Application No. 10 2010 021 472.8 filed 25 May 2010, the content of which is incorporated herein by reference in its entirety.

### BACKGROUND OF THE INVENTION

1. Field of the Invention

The invention relates to a method for interchanging data between two devices in a network which utilizes a communication protocol with an interface in accordance with the OPC-UA standard to interchange the data. The invention also relates to an apparatus for interchanging data between two devices and to a network with at least two devices and with such an apparatus.

2. Description of the Related Art

Crevatin, M. et al. “Security of Industrial Communication Systems” Proceedings of the IEEE, Vol. 93 No. 6, 1^{st} Jun., 2005, pages 1152-1177 (“Crevatin”) describes a method for interchanging data between two devices of a network which utilizes a protocol with an interface according to the Object Linking and Embedding for Process Control (OPC) standard for interchanging the data. Independently thereof, Crevation cites the use of IEEE 802.IQ VLAN and priority schemes to make fast transmission of data possible with a very low time delay for time-critical applications by bypassing IP layers.

WO 2007/105979 A1, within the context of a synchronization of a software agent with a system cycle in an automation system, cites an OPC-UA (United Architecture) interface to make Web-based access possible to parts of an automation system.

FIG. 1 shows a schematic block diagram of an automation network. At what is referred to as the field level of an automation plant, there are a number of devices 8 that receive data from sensors 10 and output suitable control data to actuators 9. The devices 8 in such cases can be in active contact as independent computers with the sensors 10 and the actuators 9, or the devices 8 can involve embedded systems. In particular, the devices 8 can have their own control firmware. In addition, a computer 7 is shown, by way of example, which is present at the control level (PLC). The computer 7 and the devices 8 are used for open-loop and closed-loop control of assigned machines of a plant. Within the automation network, they are present in the subnetworks of the field network 4 or plant floor network 3.

A link is formed between the plant floor network 3 and an automation network 2 by a computer 6 with a Supervisory Control and Data Acquisition (SCADA) system. The computer 6 is thus part of the process control level, through which technical processes in the plant floor network 3 or field network 4 are supervised and controlled.

At a higher level of the automation network, a computer 5 can be provided as a part of an enterprise network 1. This can contain a Manufacturing Execution System (MES) and thus be part of the operation control level. As an alternative, the computer 5 can be equipped, as a part of the enterprise level, with an Enterprise Resource Planning (ERP) System. This ERP system used at the office level provides complex software for supporting resource planning of an enterprise (e.g., SAP system).

For network communication at the office level, it is usual to employ hub systems without real-time capabilities. As a new standard in network communication, what is known as the OPC Unified Architecture (OPC-UA) system in accordance with the specifications of the OPC Foundation has become established between the SCADA system of the computer 6 and the ERP system of the computer 5. In data communication in accordance with OPC-UA data (values) are assigned a quality to which the rate with which the value is to be updated also belongs. Only data that has changed and the properties of which indicate that the respective value must be transmitted is transmitted. The OPC-UA thus provides event-based communication. Here, OPC-UA is based on a Remote Procedure Call (RPC) mechanism, as is known, for example, in standard Ethernet, TCP/IP (Transmission Control Protocol/Internet Protocol) or also http-based networks. In accordance with the RPC-mechanism, a request of a client on a server leads to a procedure being called on this server that processes the request. Only when the processing of the request is completed and a response has been sent by the server to the client can this process that was interrupted by the request continue. This involves the classical communication architecture of Interprocess Communication (IPC) in distributed systems. Ancillary processes are dependent on one another in a causal manner.

On the other hand, OPC-UA knows the mechanism of what are known as subscriptions. In such cases, a recipient subscribes to a specific choice of information or data from a sender. If there is a change in this amount of information or choice of subdata, the sender sends these changes automatically to the recipient. Parameters are able to be set for this mechanism since the period of time in which changes are to be sent at the earliest can be prescribed, for example.

OPC-UA provides the industry with a standard protocol with the aid of which it is possible, on the one hand, to model the widest variety of information (alarms, process values etc.) in an information model and, on the other hand, also to transport the information. For this purpose, there are what is known as the Service Sets and Services, which provide the corresponding functionalities. For the first time, it is possible with OPC-UA to use this convenient information transmission in the embedded sector as well. This makes OPC-UA a powerful tool in the area of information modeling.

While OPC-UA is today primarily used in the automation network 2, for example, in SCADA systems, entirely different demands are to be imposed on the communication protocols in the plant floor network 3 or field network 4. In automation, it is necessary to synchronize a number of devices 8 over communication paths. The requirements for this synchronization are very diverse. They extend right through to rigid real-time demands, for example, in the synchronization of drive axes of a paper factory. Especially in the plant floor, where the field level meets the office level, Ethernet-TCP/IP-based infrastructures already employed for example for communication between head controllers and/or SCADA/MES systems.

In these cases, it is usual to use clocked protocols. This means that the time is broken down into time slices and the way in which a device may send and how much it may send in a clock period is pre-planned precisely. Cyclic process images (tables with input/output values) are interchanged between the communication partners. The following rule applies here: The shorter the cycle (higher clock), the better that the synchronization capability and the more data has to be transferred permanently. A doubling of the clock rate leads to the doubling of the entire communication volume. All data is always sent in each cycle, regardless of whether the same time requirements apply for all values or whether values have changed. At the field level, this communication principle is normal in automation technology to enable the tough real-time requirements obtaining at this level to be fulfilled.

In the area of the decentralized periphery, real time communication can occur in such cases, for example, via the Profinet IO communication protocol. It makes possible interchange of data between Ethernet-based field devices 8. A further Ethernet-based approach for automation technology is Industrial Real Time Ethernet (IRTE). In accordance with IRTE, communication on the network is completely pre-planned so that undesired data collisions are excluded. This model is very static, however, because it cannot react to changes without new planning. The planning is very complex and can only be achieved with the aid of a tool since time delays caused by cable lengths, for example, also have to be taken into account. With IRTE, line structures are primarily planned. The advantage lies in the fact that more rigid determinism is produced.

This means that the office or process control level and the field level are separated in respect of the communication protocols used in their subnetworks. The respective communication protocols employed fulfill different requirements. It may be that the real time requirements, which are obtained at the field level, are of no significance for the office level. The term “vertical integration of automation technology” is to be understood as the aim of integrating the different subnetworks and creating a uniform communication structure from the enterprise level right down into the field level.

### SUMMARY OF THE INVENTION

It is an object of the invention to provide a method, an apparatus and a network with which it is possible to achieve an improved integration of subnetworks.

This and other objects and advantages are achieved in accordance with the invention by providing a method, an apparatus and a network, wherein the method is used for the exchange of data between two devices of the network which, for interchange of data, utilizes the communication protocol with an interface in accordance with the OPC-UA standard. Here, communication protocol comprises an interface in accordance with the Stream Reservation Protocol (SRP) standard or Multiple Stream Registration Protocol (MSRP) standard according to IEEE 802.1Qat, so that the data is interchangeable between the two devices via two interfaces in a prescribed period of time.

OPC-UA (Object Linking and Embedding for Process Control Unified Architecture) is an OPC Specification of the OPC Foundation and is described at www.opcfoundation.org. The Stream Reservation Protocol (SRP) or Multiple Stream Registration Protocol (MSRP) are standardized interfaces of the Audio-Video-Bridging Task Group and characterize the streaming of audio and video data over networks. The invention is based on the idea of modifying OPC-UA by Audio-Video-Bridging (AVB) such that the OPC-UA communication without actual real-time capabilities has real-time properties. The fact that the data is able to be interchanged between the two devices via two interfaces in a prescribed period of time means that it especially satisfies real-time requirements or the requirements of a real-time system. What is to be understood by real time is defined in particular in DIN 44300. It can especially involve what is referred to as hard real-time. In an embodiment, the RPC-like form of communication of OPC-UA is retained, where, however, the underlying transport is mapped to AVB. In preferred embodiments, a protocol layer of OPC-UA is modified and/or interchanged through the SRP/MSRP interface.

The combination of an OPC-UA and SRP/MSRP interface in a communication protocol makes possible real-time-capable communication that meets even complex requirements, such as axis synchronization. The communication protocol realized in this way can be implemented in a simple and uncomplicated manner in field-level devices. In addition, interchange of data with OPC-UA-based devices of higher levels, such as the automation network or enterprise network, can be ensured without problems. A high degree of inter-compatibility between subnetworks of an automation technology plant is achieved and the vertical integration is significantly improved. The communication protocol is characterized by high efficiency, because especially as a result of the OPC-UA components, superfluous interchange of data is securely avoided. At the same time, the MSRP/SRP component ensures real-time functionality.

The communication protocol is preferably constructed in a number of layers, where an interface is assigned to each layer, and where for a first type of data, it passes through a sequence of layers in accordance with the OPC-UA standard and for a second type of data, when the data passes through the sequence of layers in accordance with the OPC-UA standard the method deviates such that the SRP or MSRP interface is used and the second type of data is interchanged between the two devices in the prescribed period of time. In this case, it is especially preferable for the communication protocol to be constructed in accordance with the Open Systems Interconnection Reference Model in a number of layers. The data of the first type can especially involve such data as it does not have to satisfy any real time requirements. The presently contemplated embodiment allows the OPC-UA communication protocol architecture to be used for non-real-time-critical data, while real-time-relevant data deviates from the conventional OPC-UA protocols in that it uses the newly provided MSRP/SRP interface. In this case, ideal use is made of both the power of OPC-UA with respect to the interchange of data and also the strength of AVB with respect to its real-time characteristics in accordance with the respective type of data.

Preferably, the communication protocol includes an application layer, an OPC-UA interface, a TCP/IP interface, an Ethernet interface and a physical interface. The first type of data passes through these interfaces, while for the second type of data at least the TCP/IP interface is bypassed. Bypassed is to be understood as the data not passing through the TCP/IP interface or the interface not being used with respect to the processing of data. Instead of the TCP/IP interface, the data preferably passes through the SRP/MSRP interface. In an embodiment, a Unified Architecture layer subordinate to the OPC-UA interface is suitably modified for the processing of the second type of data. In preferred embodiments, at least the application layer and the physical interface remain completely unchanged in comparison to the OPC-UA standard. This embodiment allows a significant expansion of the functional scope of a communication protocol based on OPC-UA with simultaneously only slight changes within the layer system underlying the communication protocol. Programming can be implemented more easily. Interface access is arranged in a very simple way for a program developer.

Preferably, a data window provided by the SRP or MSRP interface is subdivided into a number of temporally consecutive subdata windows. This embodiment allows very good organization of the transmission of data between the two devices. The flexibility with respect to filling the data window with data is improved. In addition, the clock rate in the data transmission can potentially be improved.

It is especially preferred for the second type of data to be transferred in subdata windows, through which a first subset of subdata windows is formed and a second subset of subdata of subdata windows that is disjoint from the first subset is used for the transmission of the first type of data. In particular, real-time-critical data can then be transmitted in subdata windows provided specifically for this purpose, while remaining subdata windows are available for the transmission of non-real-time-critical data. Free resources for data transmission can be used very well in this way. There is the option of transmitting large amounts of data and yet still guaranteeing real-time capability.

It is also an object to provide an apparatus for interchanging data between two devices of the network which, for interchanging the data, utilizes a communication protocol with an interface in accordance with the OPC-UA standard. In accordance with the invention, the communication protocol comprises an interface in accordance with the Stream Reservation Protocol (SRP) standard or Multiple Stream Registration Protocol (MSRP) standard according to IEEE 802.1Qat, so that the data is interchangeable between the two devices via both interfaces in a prescribed period of time.

It is also an object to provide a network that comprises at least two devices and the apparatus in accordance with the invention.

The preferred embodiments presented with regard to the inventive method and their advantages apply correspondingly to the inventive apparatus and also the inventive network.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in greater detail below on the basis of exemplary embodiments, in which:

FIG. 1 shows a schematic block diagram of a multilayer network of a conventional automation technology system;

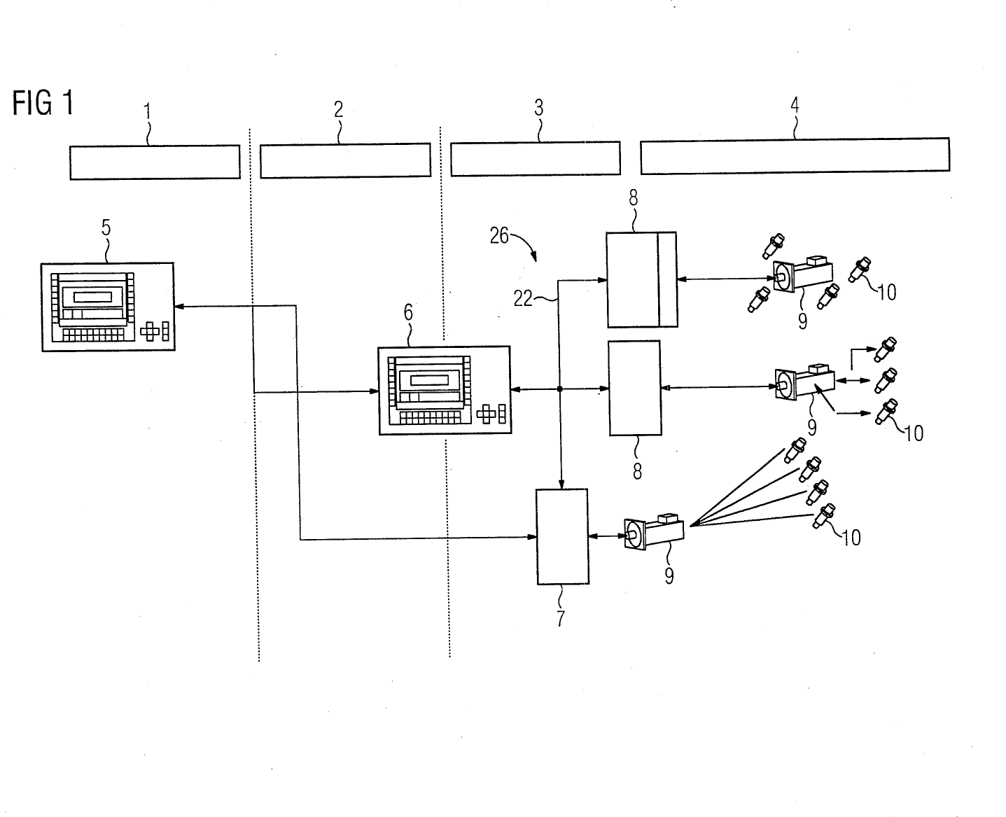

FIG. 2 shows a schematic block diagram of data interchange between two devices of the network which is controlled by a communication protocol in accordance with an exemplary embodiment of the method in accordance with the invention; and

FIG. 3 shows a schematic block diagram of the subdivision of data windows in an AVB stream into subdata windows in accordance with the invention; and

FIG. 4 is flowchart of the method in accordance with the invention.

### DETAILED DESCRIPTION OF THE PREFERRED EMBODIMENTS

Elements that are the same or have the same function are provided with the same reference characters in the figures.

The invention allows OPC-UA to be used in the area of real-time communication (deterministic communication). OPC-UA, which was previously mainly used in automation network 2 (for example, in computer 6 with the SCADA system) can now penetrate down into the plant floor network 3 or field network 4. Using the proposed method, the area of application of OPC-UA is expanded downwards into the pyramid within the automation pyramid. Efforts are being made to also use OPC-UA down to computer 5 with the ERP or MES system in Enterprise Network 1. Consequently, an end-to-end communication and uniform view of the process data is therefore obtained from the lowest level through to the ERP level. The same technology is used in all areas, which ensures full interoperability without the need for additional hardware (mappers or converters).

A strength of OPC-UA is its power in information modeling, which is simultaneously used to improve the interoperability of components or make the interoperability possible. All devices 8 involved not only deliver their process values, but in addition in the information model deliver semantic information as well via these values. This advantage is now effective—without additional outlay—right down into the plant floor network 3.

A basic idea is to retain the RPC-like form of communication of OPC-UA and, in doing so, to map the subordinate transport onto AVB. AVB makes available prioritizable streams, of which the bandwidth is able to be prespecified and of which the bandwidth is then also guaranteed. AVB is used in the prior art for transmission of audio and video streams. Here, the basic requirement is to transmit large amounts of data (image information) reliably and quickly. Were AVB not to fulfill this basic condition, what are known as frozen and dropped frames would occur in the image. This basic requirement, however, precisely matches the real-time requirements in automation technology. One idea therefore consists of modifying OPC-UA via AVB and making it real-time-capable in this way.

Typically, the subscriptions (more precisely: the change messages of a subscription) are transported here by AVB technology, which for its part assures a required transmission quality. The result achieved by this combination is that real-time-capable communication based on OPC-UA is made possible.

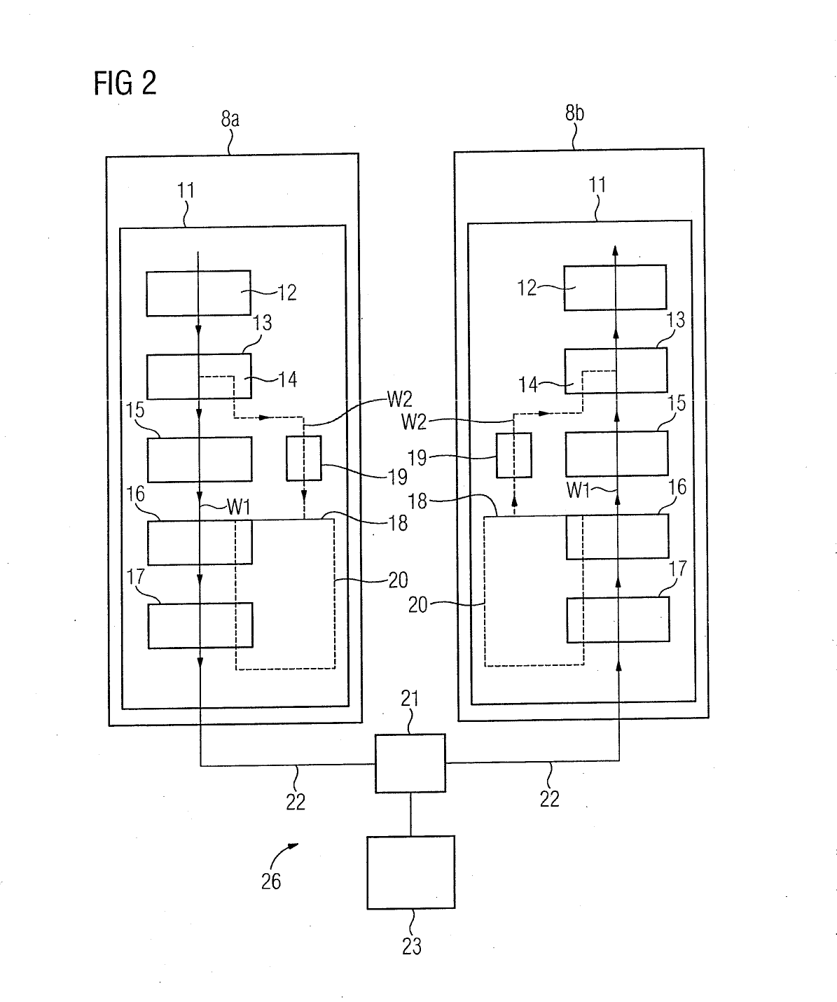

The communication principle between two devices 8a and 8b is shown by way of example in FIG. 2. Both devices 8a and 8b comprise a computer in which the executable communication protocol 11 is installed. Here, the communication protocol 11 comprises a number of layers with associated interfaces. Individually, these are an application layer 12, a Unified Architecture (UA) stack 14 with an OPC-UA interface 13, a TCP/IP interface 15, an Ethernet interface 16 and also a physical interface 17. In addition an MSRP/SRP interface 18 is now provided, which makes an AVB functionality 20 available. In parallel to the TCP/IP layer a Real Time Unified Architecture (RT-UA) layer 19 is now provided.

The two devices 8a and 8b are connected to one another via a data line 22 and a switch or router 21. In the exemplary embodiment, the data line 22 involves an Ethernet copper cable. As an alternative, however, any given type of data line 22 can be provided, which can comprise, for example, a wired connection, a connection based on glass fiber or a wireless-based connection (for example, WLAN). The router 21 must especially be configured so that it supports the communication protocol 11. A computer 23 is also connected to the router 21. If executable program code is installed on the computer 23 which makes possible communication in accordance with the OPC-UA standard, this computer 23 can easily communicate with the devices 8a and 8b. In particular, no real-time expansions in communication protocol 11 have to be provided in the computer 23 to still make easy communication possible with the devices 8a and 8b.

The device 8a enters into communication with the device 8b and in doing so determines real-time-critical data and also non-real-time-critical data. Real-time-critical data, for example, involves movement sequences of movable parts of the device 8a. For example, the device 8b may only perform a specific movement sequence after the device 8a has performed a movement sequence itself. If this temporal sequence is not adhered to, the devices 8a and 8b collide with one another. This is to be avoided. Therefore, a narrow period of time is prescribed in which the interchange of the real-time-critical data between the devices 8a and 8b must occur. This data is processed in communication protocol 11 in accordance with the path W2 indicated by a dashed line. In accordance with the path W2, the data passes through the individual layers or interfaces of the communication protocol 11 such that the MSRP/SRP interface is used. The real-time-relevant data is then transported by AV streams and thus fulfils the real-time requirements. The data thus passes through the RT-UA layer 19. This is also the case in communication protocol 11 of device 8b.

However, the devices 8a and 8b also interchange non-real-time-critical data. For example, the device 8a regularly notifies the device 8b about its operating temperature. In such cases, it is of no significance whether this information arrives at device 8b in a prescribed time window. For the interchange of this data, the conventional data processing path W1 provided by the OPC-UA standard within the communication protocol 11 is selected. The TCP/IP interface 15 is not bypassed, by contrast with path W2; the MSRP/SRP interface 18 is not used.

AVB technology is characterized by high bandwidth at a comparatively low clock rate. In automation technology, however, the requirement profile is precisely the reverse. In accordance with the OPC-UA subscriptions, only comparatively small amounts of data are to be transmitted. As a result, a lower bandwidth than that usually provided by AVB is sufficient. On the other hand, a higher clock rate would be desirable.

However, AVB provides the opportunity to realize a higher clock rate at the expense of the lower bandwidth. A higher clock rate can, for example, be achieved by the time that is required for transmitting a video frame (Video Frame Length T, as a rule 1/25s in PAL) being divided up into a number of time slots 24 of the same size. This means that each of these slots 24 has a correspondingly smaller clock time or slot length t1. Thus, a higher clock rate is achieved. Naturally correspondingly less data can also be transmitted in each of these slots 24. This is not a problem in automation technology, however, because compared to video stream data, significantly less useful data has to be transmitted per slot 24.

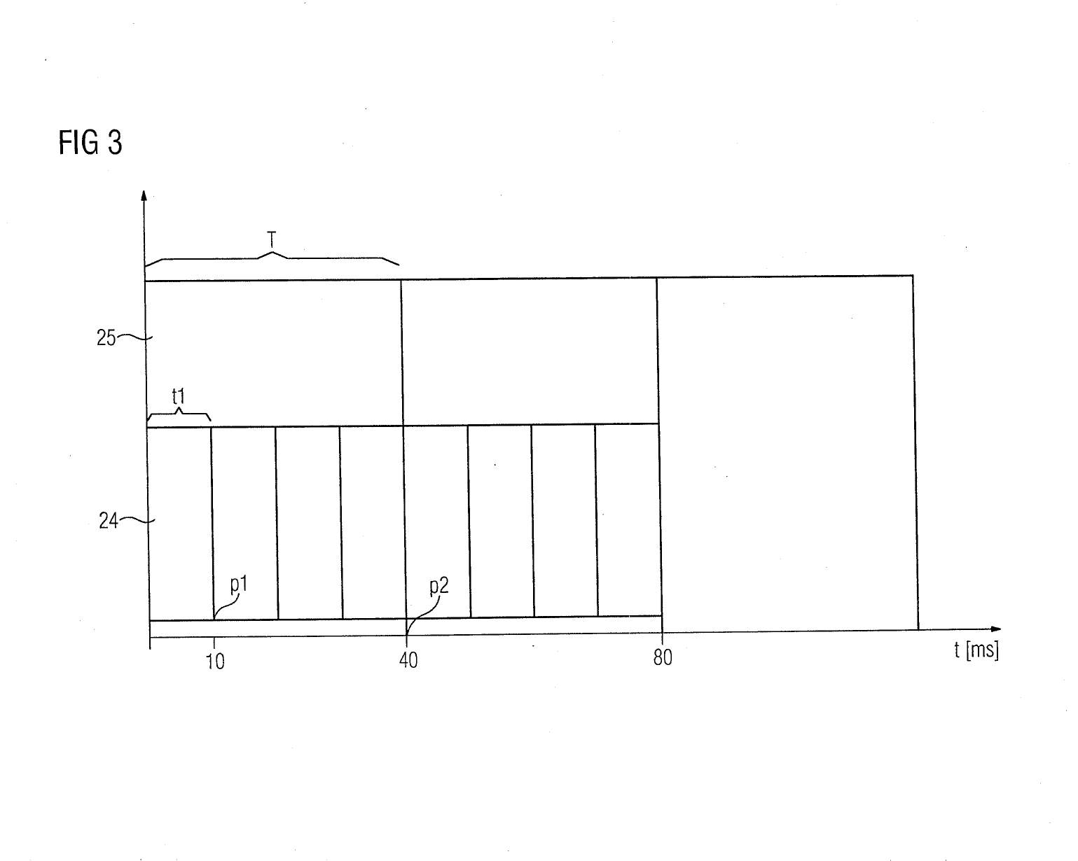

In the exemplary embodiment of FIG. 3, a data window 25 of length T=40 ms is divided into four equal-length slots 24 with a slot length t1=10 ms. Due to the synchronization of the data windows 25 or frames, these slots 24 are accordingly also only synchronized at this rate (e.g. 1/25s) (cf. sync point p2). This is, however, entirely sufficient because the jitter in the individual slots 24 (pseudo sync point p1) is small enough to remain in the jitter tolerance within the frame rate. The guaranteed bandwidth of AVB makes it possible, with respect to the subscriptions or real-time-relevant data, to leave slots unused when no such data is to be transmitted (e.g., because there was no change in value in the subscription). This freed bandwidth is automatically used by AVB for transmission of other non-real-time-relevant data. The reserved bandwidth or the unused slots 24 are consequently available for other types of communication between the devices 8a and 8b. This is referred to as “breathing” communication.

Overall the advantages provided by OPC-UA and AVB within communication on the network 26 are combined in an optimal manner. The principle of subscriptions used in OPC-UA guarantees that all relevant data is transferred with a simultaneously smaller amount of data. On the other hand, the real-time capability and intelligent bandwidth management is provided by AVB. Bandwidth management and real-time communication are thus managed locally. Central preplanning of the communication is no longer necessary. Despite this, the amount of data able to be transmitted increases overall. Data for deterministic and non-deterministic communication can be processed very well by the communication protocol. In addition, a high degree of interoperability on the network 26 is ensured.

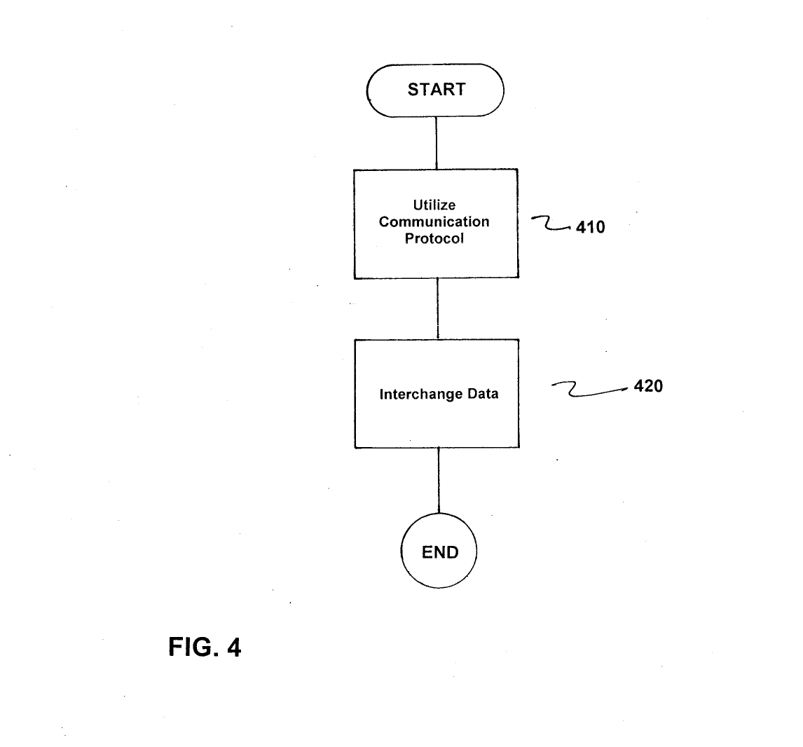

FIG. 4 is a method for interchanging data between two devices of a network. The method comprises utilizing a communication protocol with an interface in accordance with an Object Linking and Embedding for Process Control United Architecture (OPC-UA) standard for interchanging the data, as indicated in step 410.

The data is then interchanged between the two devices via both interfaces in a prescribed period of time, the communication protocol including an interface in accordance with one of a Stream Reservation Protocol (SRP) standard and a Multiple Stream Registration Protocol (MSRP) standard in with IEEE standard 802.1Qat, as indicated in step 420.

While there have shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-7. (canceled)

8. A method for interchanging data between two devices of a network, the method comprising:
utilizing a communication protocol with an interface in accordance with an Object Linking and Embedding for Process Control United Architecture (OPC-UA) standard for interchanging the data; and
interchanging the data between the two devices via both interfaces in a prescribed period of time, the communication protocol including an interface in accordance with one of a Stream Reservation Protocol (SRP) standard and a Multiple Stream Registration Protocol (MSRP) standard in with IEEE standard 802.1 Qat.

9. The method as claimed in claim 8, wherein the communication protocol is configured in accordance with an Open Systems Interconnection Reference Model as a multilayer protocol;
wherein each layer is assigned an interface; and
wherein, for a first type of data a layer sequence in accordance with the OPC-UA standard is executed (W1) and for a second type of data, during execution, deviation (W2) from the layer sequence occurs in accordance with the OPC-UA standard (W2), such that one of an SRP or MSRP interface is used and the second type of data is interchanged between the two devices in the prescribed period of time.

10. The method as claimed in claim 9, wherein the communication protocol comprises an application layer, an OPC-UA interface, a TCP/IP interface, an Ethernet interface and a physical interface, through which the data passes for the first type of data; and wherein at least the TCP/IP interface is bypassed for the second type of data.

11. The method as claimed in claim 10, further comprising:
subdividing a data window provided by the SRP or MSRP interface into a number of temporally consecutive subdata windows.

12. The method as claimed in claim 11, wherein the second type of data is transmitted in the subdata windows, through which a first subset of subdata windows is formed, and a second subset of subdata windows, which is disjoint from the first subset of subdata windows, is used for transmission of the first type of data.

13. An apparatus for interchanging data between two devices of a network which, for the interchange of the data utilizes a communication protocol including an interface in accordance with an Object Linking and Embedding for Process Control United Architecture (OPC-UA) standard;
wherein the communication protocol comprises one of an interface in accordance with a Stream Reservation Protocol (SRP) standard and an interfance in accordance with a Multiple Stream Registration Protocol (MSRP) standard in accordance with IEEE standard 802.1Qat, so that the data is interchangeable between the two devices via both interfaces in a prescribed period of time.

14. A network having at least two devices and the apparatus as claimed in claim 13.
